(19) United States
(12) Patent Application Publication
(10) Pub. No.: US 2008/0044002 A1
(43) Pub. Date: Feb. 21, 2008

(54) Wireless headset with extendable microphone

(76) Inventors: Joeben Bevirt, Santa Cruz, CA (US); David Eliot Scheinman, Woodside, CA (US)

Correspondence Address: MICHAEL A. GUTH, 2-2905 EAST CLIFF DRIVE, SANTA CRUZ, CA, 95062, US

(21) Appl. No.: 11/488,957

(22) Filed: Jul. 19, 2006

(51) Int. Cl. H04M 1/00; H04M 9/00

(52) U.S. Cl. 379/430

(57) ABSTRACT

A headset utilizing aN extendable microphone boom that positions the microphone closer to the user's mount when deployed. A wireless headset that is adjustable to the user's face and ear geometry through the use of a flexible joint between the headset housing and the earpiece. A wireless headset utilizing very thin housing construction through the use of metal. A wireless headset which can be used with a second speaker for the user's other ear. A wireless headset which uses a deployable microphone boom that deploys into a curved position.

### BACKGROUND

1. Field of the Invention

The present invention relates to hands-free communication devices, and more particularly to a headset with an extendable microphone boom.

2. Description of Related Art

A headset may be used in conjunction with a telephone device for several reasons. With a headset, the user is relived of the need to hold the phone and thus retains his or her hands free to perform other functions. Headsets also function to position the earphone and microphone portions of a telephone close to the user's head to provide for clearer reception and transmission of audio signals with less interference from background noise. Headsets may be used with telephones, computers, cellular telephones, and other devices.

The wireless industry has launched several after-market products to free the user form holding the phone while making phone calls. For example, various headsets are manufactured with an earpiece connected to a microphone and most of these headsets or hands-free kits are compatible with any phone brand or model. A possible headset can be plugged-in to the phone and comprise a microphone connected via wires to the headset so that the microphone, when in position, can appropriately capture the voice of the user. Other headsets are built in with a Bluetooth chip, or other wireless means, so that the voice conversation can be wirelessly diverted from the phone to the earpiece of the headset. The Bluetooth radio chip acts as a connector between the headset and a Bluetooth chip of the cell-phone.

A drawback of many of the available headsets is that they are either very large, or, if smaller, place the microphone of the headset far from the user's mouth, which may introduce noise problems into the communication system. Another drawback to available headsets is the lack of adjustment in the headset to the user's facial and head geometry.

What is called for is a wireless headset that is both very small but also allows for placement of the microphone closer to the user's mouth. What is also called for is a headset which flexes to conform to the user's facial geometry.

### SUMMARY

A headset utilizing an extendable microphone boom that positions the microphone closer to the user's mouth when deployed. A wireless headset that is adjustable to the user's face and ear geometry through the use of a flexible joint between the headset housing and the earpiece. A wireless headset utilizing very thin housing construction through the use of metal. A wireless headset which can be used with a second speaker for the user's other ear. A wireless headset which uses a deployable microphone boom that deploys into a curved position.

### BRIEF DESCRIPTION OF THE DRAWINGS

FIGS. 1A-B are headsets seen being worn by a user according to some embodiments of the present invention.

FIGS. 2A-B are sketches of a headset according to some embodiments of the present invention.

FIGS. 3A-B are sketches of a headset with its microphone boom both stowed and extended according to some embodiments of the present invention.

FIGS. 4A-C are sketches of boom deployment details according to some embodiments of the present invention.

FIG. 5A-C are sketches of boom details including a housing according to some embodiments of the present invention.

FIGS. 6A-B are sketches of boom deployment details including a housing according to some embodiments of the present invention.

FIGS. 7A-B are sketches of an exploded view of an ear piece and a housing connected with a flexible joint according to some embodiments of the present invention.

FIGS. 8A-B are sketches of an exploded view of an ear bud and a housing connected with a flexible joint connected together at the back end of the housing according to some embodiments of the present invention.

FIG. 9 is a sketch of a headset with a second ear speaker according to some embodiments of the present invention.

FIG. 10 is a sketch of a headset with a removable second ear speaker according to some embodiments of the present invention.

FIGS. 11A-C are sketches of boom deployment details using a wound boom including a housing according to some embodiments of the present invention.

FIGS. 12A-C are sketches of boom deployment details using a different type of wound boom including a housing according to some embodiments of the present invention.

FIG. 13 is a sketch of deployed telescoping boom according to some embodiments of the present invention.

FIG. 14 is a sketch of a stowed telescoping boom according to some embodiments of the present invention.

FIGS. 15A-B are sketches of a fold out boom deployment system according to some embodiments of the present invention.

FIG. 16 is a sketch of a boom deployment system according to some embodiments of the present invention.

FIG. 17 is a sketch of a stowed boom deployment according to some embodiments of the present invention

FIG. 18 is a sketch of a deployed boom deployment system according to some embodiments of the present invention.

FIGS. 19A-D illustrate a microphone wiring system for a deployable microphone boom according to some embodiments of the present invention.

FIGS. 20A-D illustrate a microphone wiring system for a deployable microphone boom according to some embodiments of the present invention.

FIGS. 21A-E illustrate a microphone wiring system for a deployable microphone boom according to some embodiments of the present invention.

FIGS. 22A-C illustrate a microphone boom deploy switch system according to some embodiments of the present invention.

FIGS. 23A-D illustrate the internal configuration of a headset according to some embodiments of the present invention.

FIGS. 24A-C illustrate a headset with an earloop according to some embodiments of the present invention.

### DETAILED DESCRIPTION

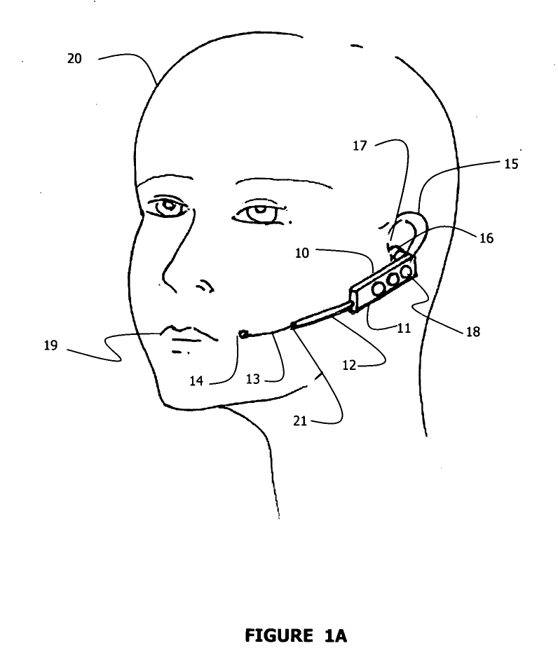

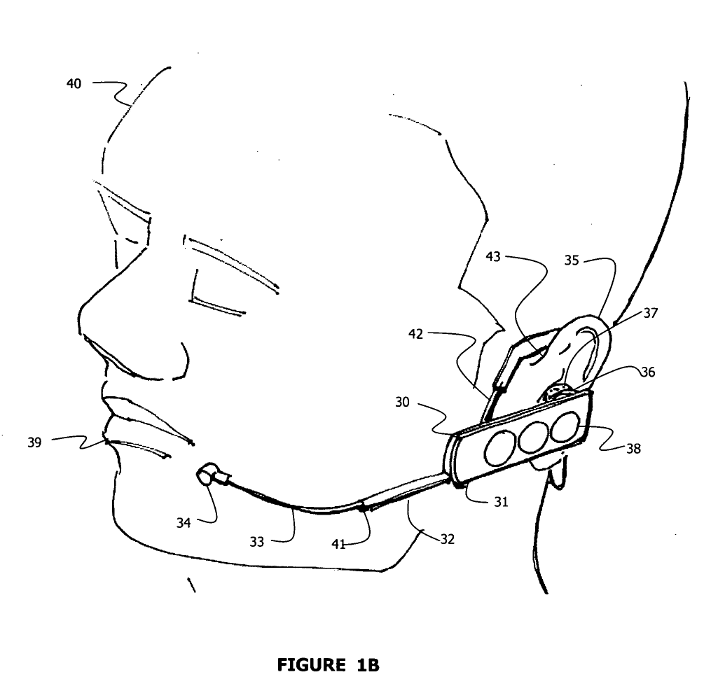

FIG. 1A illustrates a user wearing a headset according to some embodiments of the present invention. The headset 10 is adapted to attach to the user's ear 15. The earpiece 16 is adapted to fit into the ear canal 17. In some embodiments, the headset 10 is wholly supported on the user's head 20 by the fit of the earpiece 16 into the ear canal 17. The microphone boom 21 is seen in the deployed position. A first boom section 12 extends from the main body 11. A second boom section 13 extends from the first boom section 12. A microphone 14 is attached to the second boom section 13. The deployment of the microphone boom 21 places the microphone 14 in closer proximity to the user's mouth 19, which may be advantageous with regard to suppression of outside noise during communication, and also may allow the user to talk more quietly when using the headset in a public area.

The main body 11 of the headset 10 may have one or more buttons 18 which may be used to control aspects of the headset's function. The deployable nature of the microphone boom 21 allows for a very small headset. The microphone boom 21 may be stowed into or along the main body 11 of the headset. The headset may then be carried with minimal risk to the microphone boom 21, and the small size of the main body 11 of the headset 10 affords the user the convenience of having a very small package. The extendable nature of the microphone boom combines the convenience of a very small, lightweight package with the advantage of a microphone close to the user's mouth when the microphone is deployed. In some embodiments, there may be a second microphone mounted on or near the main body as well. The second microphone may be used in conjunction with the first microphone in a noise suppression regime implemented by the electronics within the main body. In some embodiments, the second microphone may be set with a different gain, and is used when the microphone boom is not deployed, with the first microphone switched on when the microphone boom is deployed. In some embodiments, the microphone 14 on the deployable boom may be adapted at a first gain level when stowed, and at a second gain level when deployed.

As seen in FIG. 1A, the microphone boom 21 may be curved when deployed to follow at least in part the contours of the user's face and to place the microphone 14 closer to the user's mouth 19. This position may be of advantage with regard to the functioning of the microphone, and may also allow for more convenience for the user physically. In some embodiments, the second boom section 13 stows within the first boom section 12. In some embodiments, the boom sections are substantially straight when stowed within the main body 11. The boom sections may both be curved when deployed, or only one of the boom sections may be curved when deployed.

FIG. 1B illustrates a user wearing a headset according to some embodiments of the present invention. The headset 30 is adapted to attach to the user's ear 35. The earpiece 36 is adapted to fit into the ear canal 37. The headset 30 is also supported on the user's head 40 by the fit of an earloop 42 over the top 43 of the ear 35. The microphone boom 41 is seen in the deployed position. A first boom section 32 extends from the main body 31. A second boom section 33 extends from the first boom section 32. A microphone 34 is attached to the second boom section 33. The deployment of the microphone boom 41 places the microphone 34 in closer proximity to the user's mouth 39, which may be advantageous with regard to suppression of outside noise during communication, and also may allow the user to talk more quietly when using the headset in a public area. The main body 31 of the headset 30 may have one or more buttons 38 which may be used to control aspects of the headset's function. The deployable nature of the microphone boom 41 allows for a very small headset. The microphone boom 41 may be stowed into or along the main body 11 of the headset.

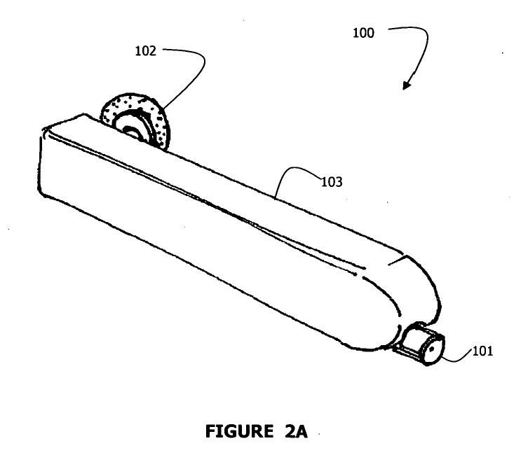

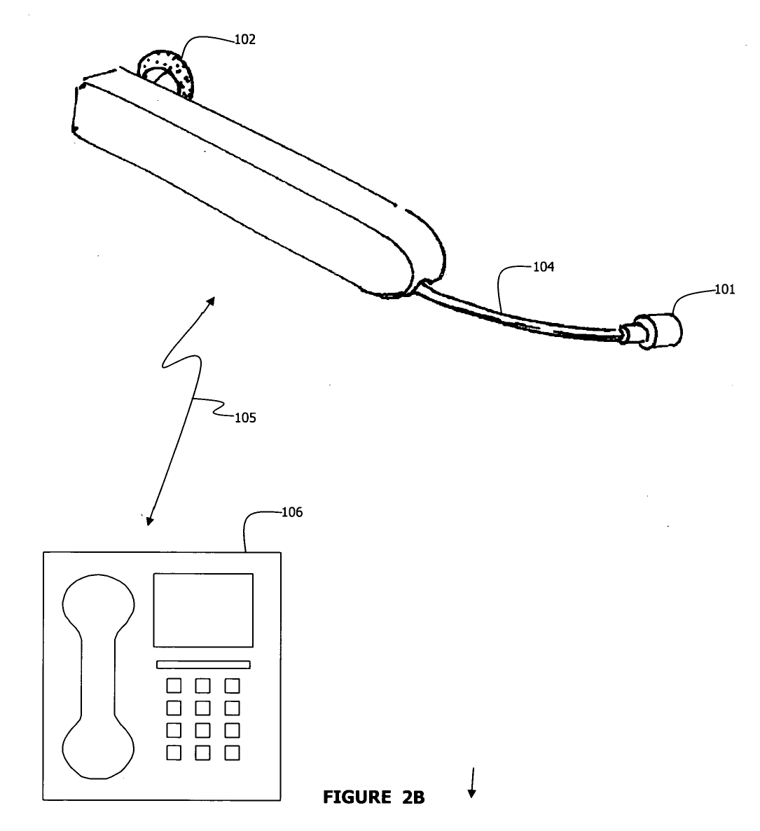

FIG. 2A shows a headset 100 according to some embodiments of the present invention. The headset is adapted for wireless communication. The headset may be used with a Bluetooth enabled system such that a voice conversation on a Bluetooth enabled cell-phone is diverted away from the cell-phone and rendered to the user via the headset. However, the headset is not limited in this fashion and may communicate with other types of devices, including but not limited to a personal digital assistant, an MP-3 player, or other system. As seen in FIG. 2B, the headset 100 communicates with a device 106 over an RF spectrum 105. The headset 100 has a main body 103 connected to an earpiece 102. A microphone 101 is attached to a microphone boom 104 which is extended from a stowed position within the housing in some embodiments. In some embodiments, the main body 103 is approximately 2.5 inches in length along its long axis. The microphone boom 104 may be substantially as long as the main body 103, or approximately 2 inches.

The microphone boom 104 is curved in some embodiments. The microphone boom 104 may be comprised of a shaped memory alloy (SMA). The SMA may be a nickel (Ni) Titanium (Ti), or NiTi alloy. A generic trade name for NiTi alloys is Nitinol. NiTi alloys may have a property called pseudoelasticity, also called superelasticity. Superelasticity describes a non-linear recoverable deformation behavior at temperatures above a certain temperature, which arises from a stress-induced martensitic transformation on loading and the spontaneous reversion of the transformation upon unloading. The use of an SMA in the microphone boom 104 allows for the boom to be substantially straight while stowed and curved while deployed. The stowed boom may be constrained into a straight shape while stowed, and free to take its curved shape when deployed. The boom curve is preset into the superelastic material. The curve of the microphone boom 104 may be adapted to curve along the face of the user towards the mouth of user. The curved shape may both enhance the functionality of the boom and microphone, and may also reduce the likelihood of damage that may occur with a straight boom that sticks further out from the user's face. The microphone boom 104 may use a single piece of NiTi alloy in some embodiments. The microphone boom may be restrained from rotating to ensure that the boom, when deployed and curved, is in a preferred position relative to the main body of the headset. In some embodiments, the microphone boom may have some rotational freedom to allow the user to adjust the position of the microphone somewhat.

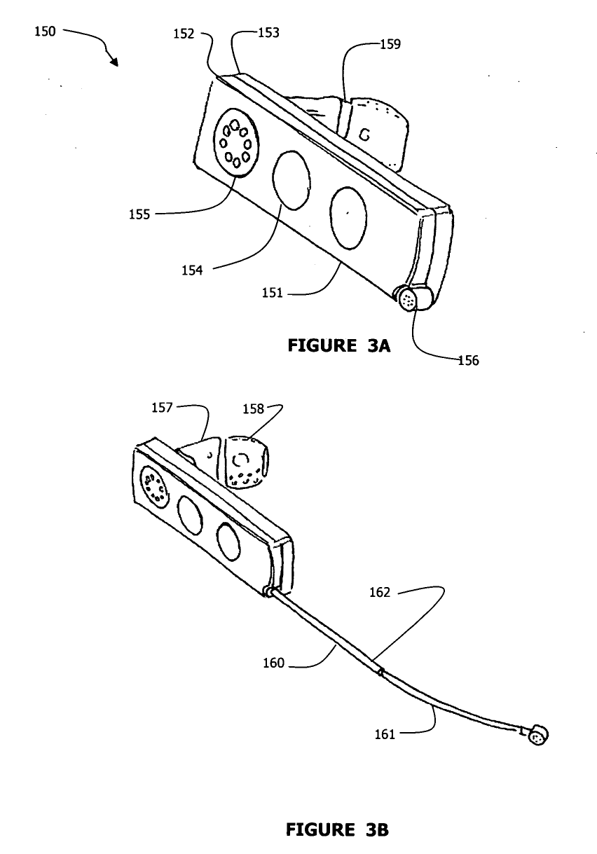

FIGS. 3A-B further illustrate a headset 150 according to some embodiments of the present invention. The main body 151 may consist of an inner housing 153 and an outer housing 152. One or more of the housing pieces may be made from metal. The inner housing 153, which is the side of the main body 151 adjacent to the user's head, may be made of metal in part to provide a shield for the RF emissions from the headset relative to the user. The use of a metal, such as magnesium, housing may give an additional advantage of allowing for a very thin wall thickness which may facilitate the construction of a very small headset. In some embodiments, a magnetically permeable metal may used. This may be used in conjunction with accessories which use a magnet to attach to the housing. An earpiece 159 is attached to the main body 151. One or more buttons 151, 154 may be positioned on the outer housing 152 of the main body 151 and may be used to implement functionalities of the headset 150. An LED panel 155 may indicate function. A microphone 156 is seen in the stowed position in FIG. 3A. The microphone boom has been stowed into the main body 151. The microphone is seen to be at an inner edge of the main body 151, and not in the center of the main body. In some embodiments, the microphone boom may stow into a position along the main body. The earpiece 159 consists of an earpiece base 157 and an ear engaging body 158. The earpiece 159 may be attached to the main body 151 with a flexible joint. The flexible joint may allow the relative position and angle of the main body of the headset and the earpiece to be adapted for user's with differing ear shapes and geometries. The ear engaging body 158 may be adapted to fit into the ear canal of the user, and may be adapted to support the headset on the user's head without additional attachments in some embodiments. In some embodiments, additional attachments may be used with the headset.

FIG. 3B illustrates the headset 150 with the microphone 156 in the deployed position. The microphone 156 can be seen now deployed from the main body 151. The microphone 156 has been deployed with an extendable microphone boom 162 which was stowed within the main body 151. The microphone boom 162 consists of a first boom section 160 and a second boom section 161. The microphone boom 162 is a telescoping boom in this embodiment; the second boom section 161 stows into the first boom section 160 when the microphone boom 162 is stowed. In some embodiments, both boom sections are made from a superelastic material. In some embodiments, one or both of the boom sections may be curved in their deployed state. In some embodiments, the boom may be restricted from rotation relative to the main body 151. In some embodiments, the boom sections may be restricted from rotation relative to each other. This may be accomplished by having the telescoping sections be made from an oval profile, or through other methods. In some embodiments utilizing a telescoping microphone boom, the microphone boom may be substantially longer than the length of the main body of the headset along its long axis. For example, the main body of the headset, with the microphone stowed and the microphone boom within the main body, may be approximately 2.5 inches in length. The microphone boom may extend out approximately 4 inches in such an embodiment. In some embodiments, the second boom section 161 is curved in its relaxed state, and the first boom section 160 is straight. The second boom section 161 is straightened as it is stowed back into the first boom section 160, and in turn as both boom sections are stowed back into the housing.

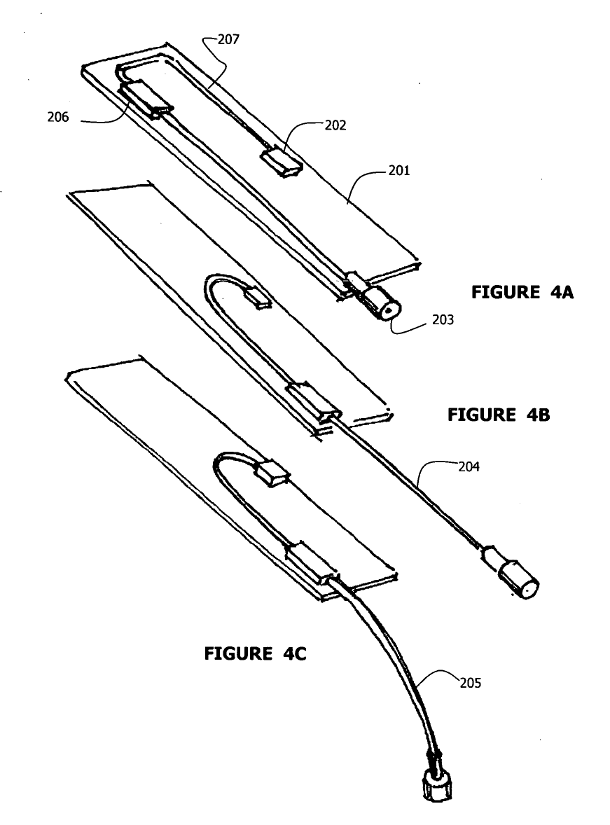

FIGS. 4A-C illustrate a microphone boom deployment system according to some embodiments of the present invention. The microphone boom 204 is adapted to deploy along the length of a substrate 201. A sliding block 206 is used to help guide the deployment and may form the junction between the microphone wire portion 207 and the microphone boom 204. The end of the wire portion 207 is anchored with a wire anchor block 202. In some embodiments, the microphone wire portion 207 will continue on through the boom 204 out to the microphone 203. In some embodiments, the wiring may be wound around the boom. In some embodiments, the boom itself may be used in the conductance of signal to the microphone. In some embodiments, a single conductor may be routed through the boom and the boom itself may act as the second conductor.

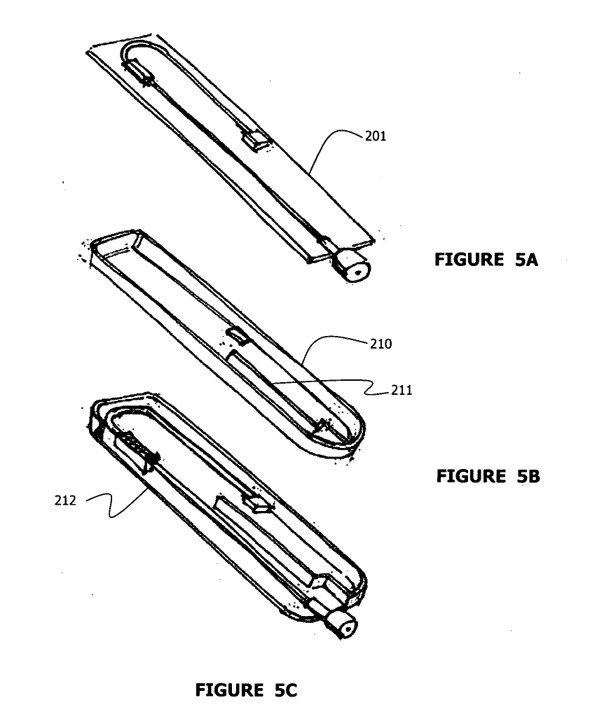

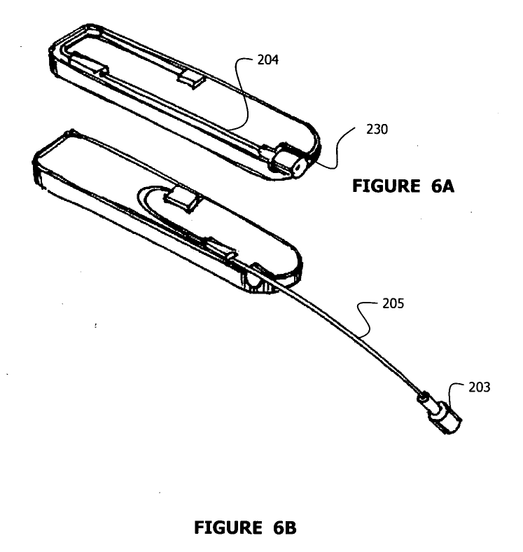

FIGS. 5A-C and FIGS. 6A-B further illustrate a microphone boom deployment system according to some embodiments of the present invention. FIG. 5A illustrates the sliding block and substrate described above. FIG. 5B illustrates the outer housing 210 in which the substrate 201 is placed as the headset is assembled. FIG. 5C illustrates a boom deployment subassembly 212. The deployment guide 211 serves as a guide for the sliding block 206. As seen in FIG. 4C, the wire portion 207 also slides down as the microphone boom deploys. For this reason, the deployment guide 211 may only extend into that housing to the point that the wire slides to during deployment. In some embodiments, the deployment guide may be lower in the affected area allowing for the guiding of the sliding block 206 without hanging up the wire portion 207. In some embodiments, the deployment guide 211 may be lower and may extend further up into the outer housing 210.

In some embodiments, the microphone boom may be wired with a pin contact or contacts located at its inner reach. These contacts may engage an electrical connection when the boom is fully deployed, and also when fully stowed, to allow the microphone to be in electrical communication with the headset electronics when deployed, but without the need for a deployable boom wiring scheme.

As seen in FIGS. 6A-B, the microphone boom 204 may be substantially straight when stowed, and the deployed microphone boom 205 may be curved. This may be accomplished using a superelastic material as described above. The deployed boom curve is adapted to position the deployed microphone closer to the mouth of the user. The boom is substantially straight while stowed as it is constrained into a straight position. The boom resumes its unconstrained shape as a curved boom when deployed.

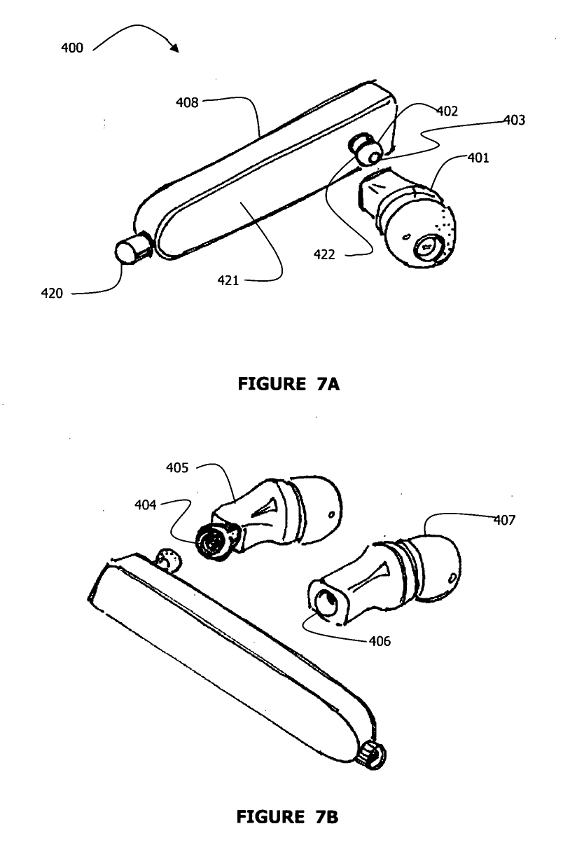

FIGS. 7A-B and 8A-B illustrate exploded views of headsets 400, 440 according to some embodiments of the present invention showing a flexible joint between the headset main body and the earpiece. A headset 400 has a main body 408 adapted to receive wireless communication. A microphone 420 is seen at the far end of the headset main body 408 from which an earpiece junction 402 is attached. The microphone 420 is seen in close proximity to the headset main body 408, but may be have an extendable boom to deploy the microphone closer to the mouth of the user.

The earpiece junction 402 attaches the main body 408 to the earpiece 401, seen in exploded view in FIGS. 7A-B. The earpiece junction 402 is attached to the main body 408 along the interior surface 421 of the main body. The attachment of the earpiece 401 to the earpiece junction 402 creates a flexible joint which allows for the adjustment of the position of the earpiece relative to the main body. The earpiece may then be adjusted by the user to best fit the user. In some embodiments, the earpiece junction 402 is a ball and socket configuration which includes a socket engaging end surface 422 which is mated into an internal socket receiving cavity 404 attached to the base 405 of the earpiece 401. The mated flexible joint allows for movement in three orthogonal axes. In some embodiments, the relative positions of the two sides of the flexible joint may be reversed; the socket engaging end surface may be on the earpiece side and the cavity may be attached to the main body of the housing. In some embodiments, the internal socket receiving cavity 406 is substantially residing within the base of the earpiece.

The socket engaging end surface 422 has a central hole 403 through the earpiece junction 402 in some embodiments. In some embodiments, the central hole 403 is a conduit through which wires pass to a speaker within the earpiece. In some embodiments, the central hole 403 is a sound channel through which sound is channeled from a speaker on the main housing side of the flexible joint. The ear engaging body 407 is adapted to fit into the ear canal of the user and to support the headset 400 on the user in some embodiments. Although described in the context of a speaker, the audio device may be a driver or other appropriate device.

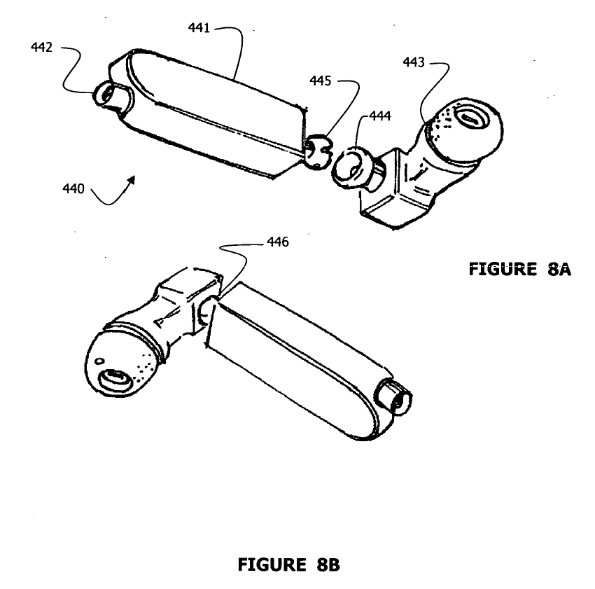

FIGS. 8A-B illustrate another embodiment of the headset 440 with a flexible joint according to some embodiments of the present invention. The earpiece junction 445 attaches the main body 441 to the earpiece 443, seen in exploded view in FIGS. 8A-B. The earpiece junction 445 is attached to the main body 441 along the top surface of the main body, that opposite from the end from which the microphone deploys. The attachment of the earpiece 443 to the earpiece junction 445 creates a flexible joint which allows for the adjustment of the position of the earpiece relative to the main body. The earpiece may then be adjusted by the user to best fit the user. In some embodiments, the earpiece junction 445 includes a socket engaging end surface which is mated into an internal socket receiving cavity 44 attached to the base of the earpiece 443. The mated flexible joint allows for movement in three orthogonal axes. In some embodiments, the relative positions of the two sides of the flexible joint may be reversed; the socket engaging end surface may be on the earpiece side and the cavity may be attached to the main body of the housing. In some embodiments, the internal socket receiving cavity 444 is substantially residing within the base 446 of the earpiece.

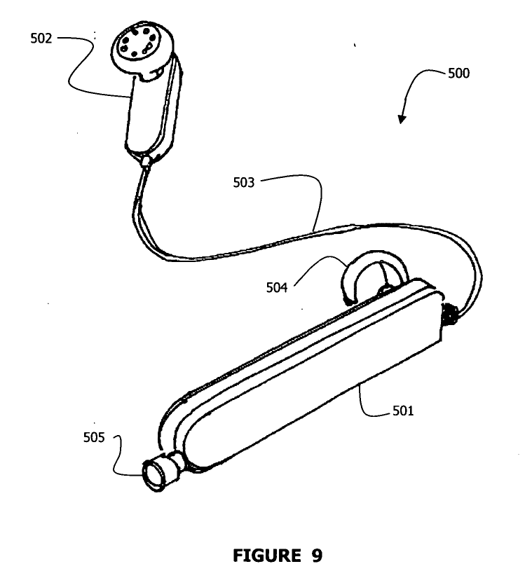

FIG. 9 illustrates a headset 500 with a second earpiece 502 according to some embodiments of the present invention. The main body 501 is seen with a microphone 505 at a first end and an earpiece 504 at a second end. The earpiece 504 is attached to the main body 501 along the interior surface of the main body 501. A second speaker 502 is electrically coupled to the main body 501 with a wire 503. The wire 503 may be hard mounted to the main body in some embodiments. The wire 503 and the second speaker 502 may be attached to the main body 501 with an easily removable plug in some embodiments. The microphone 505 may extend from the main body 501 of the headset 500 with a deployable boom in some embodiments.

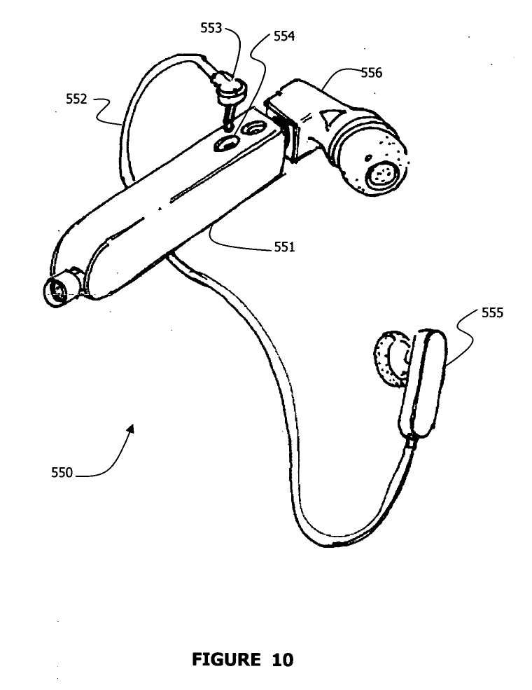

FIG. 10 illustrates a headset 550 with a second earpiece 555 according to some embodiments of the present invention. The main body 551 is seen with a microphone at a first end and an earpiece 556 at a far end. The earpiece 556 is attached to the main body 551 along the top end surface of the main body 551. A second speaker 553 is electrically coupled to the main body 551 with a wire 552. The wire 552 may be hard mounted to the main body in some embodiments. The wire 552 and the second speaker 555 may be attached to the main body 551 with an easily removable plug 553 which plugs into a mating plug 554 in some embodiments. The microphone may extend from the main body 551 of the headset 550 with a deployable boom in some embodiments.

In some embodiments, the second earpiece may be in communication with the headset using wireless communication.

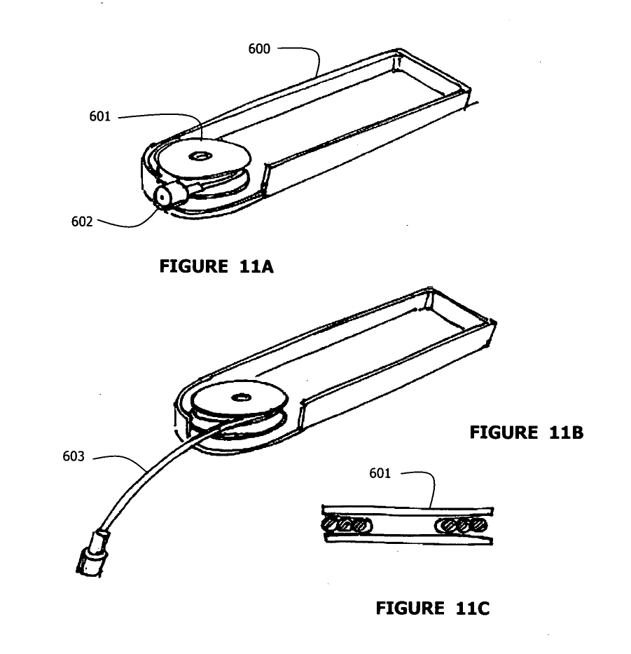

FIGS. 11A-C and 12A-C illustrate microphone boom deployment systems according to some embodiments of the present invention. FIGS. 11A-C illustrate a microphone boom 603 which deploys a microphone 602. The boom 603 is coiled around a pulley 601 attached to housing 600 when stowed. As seen in cross-section in FIG. 11C, the boom 603 is coiled around a pulley whose internal width is wide enough to accept one diameter of the boom. The boom may be made from a super elastic material such as NiTi. The boom may thus be coiled and deployed into a pre-determined shape.

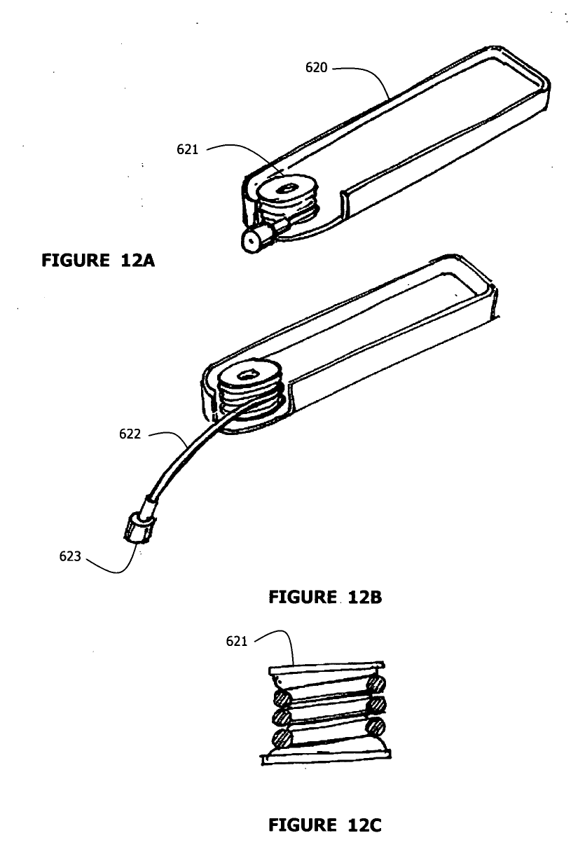

FIGS. 12A-C illustrate a microphone boom 622 which deploys a microphone 623. The boom 622 is coiled around a pulley 621 attached to housing 620 when stowed. As seen in cross-section in FIG. 12C, the boom 622 is coiled around a pulley whose internal width is wide enough to accept multiple diameters of the boom. The boom may be made from a super elastic material such as NiTi. The boom may thus be coiled and deployed into a pre-determined shape.

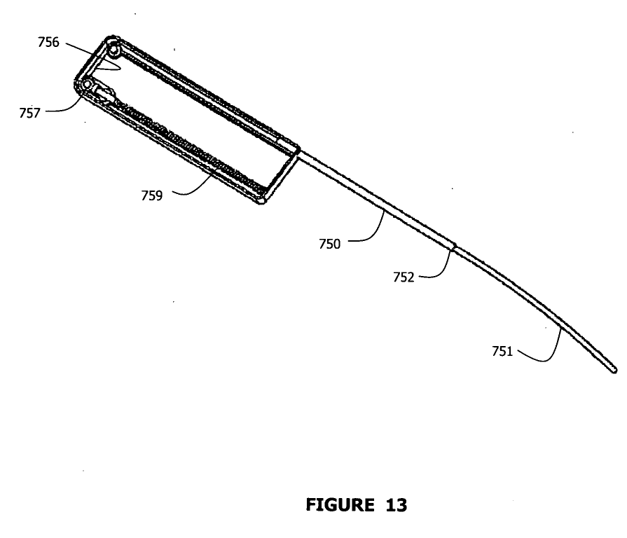

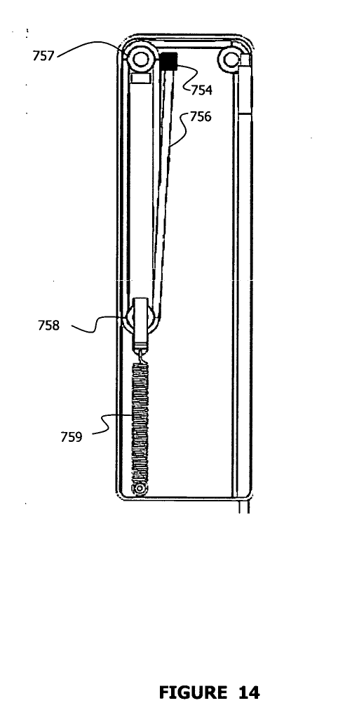

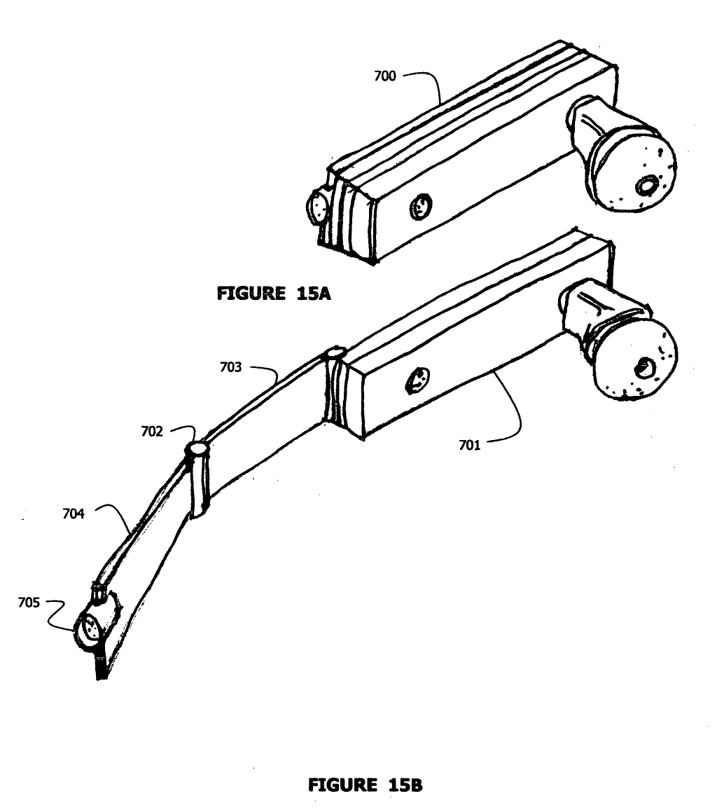

FIGS. 13 and 14 illustrate a microphone boom deployment system according to some embodiments of the present invention. A microphone boom 752 consisting of a first boom section 750 and a second boom section 751 are used to deploy a microphone. The second boom section 751 is adapted to telescope within the first boom section 750 to allow for the extension and stowage of the microphone boom 752. The boom 752 may be routed through a guide in the housing. The wiring 756 may extend down the center of the microphone boom which may be constructed out of hollow tubular elements. A pulley system may be used to retract the wiring 756 when the boom is stowed. As seen in FIGS. 13 and 14, the distance between the pulley 757 and the moving pulley 758 changes as the boom is deployed, and is much closer when deployed. The wiring 756 is played out of the space between the fixed pulley 757 and the moving pulley 758 and follows the first boom section 750 along as it deploys, as well as filling the space created within the first boom section as the second boom section telescopes out from within it. The wiring 756 may also be fastened at an anchor 754. A spring 759 fastened to the movable pulley 758 will pull the wiring 756 back in when the boom is stowed.

FIGS. 15A and 15B illustrate a headset 700 according to some embodiments of the present invention. The main body 701 is adapted to provide wireless communication to the user using a microphone and an earpiece. The earpiece may be attached to the main body with a flexible joint. An extendable microphone boom 702 may deploy from a first position along the main body 701 to a deployed position which places the microphone 705 in a position closer to the user's mouth. The microphone boom 702 may consist of a first boom section 703 and a second boom section 704. The microphone 705 may be used with a first gain at the stowed position and with a second gain at the deployed position in some embodiments.

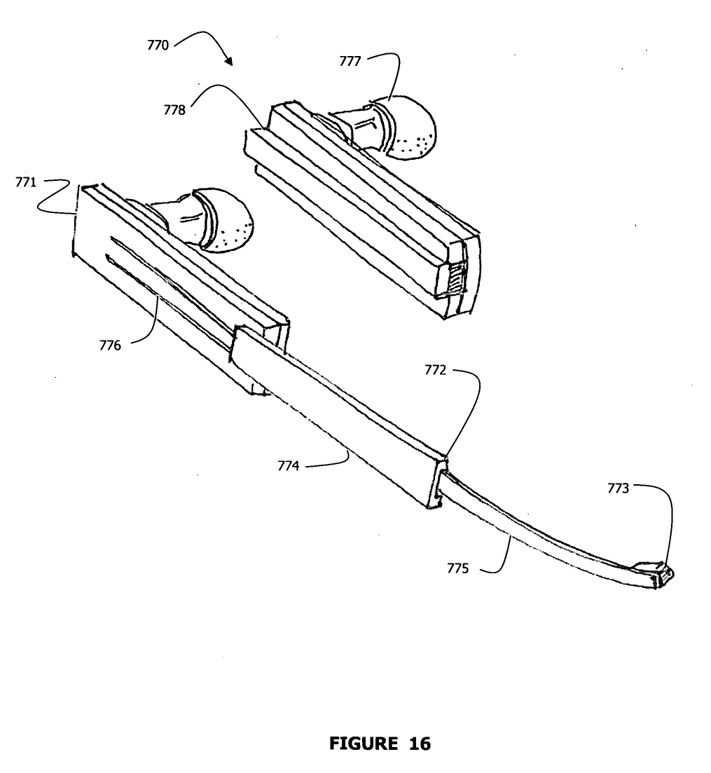

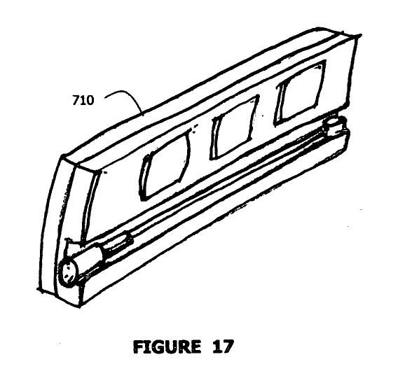

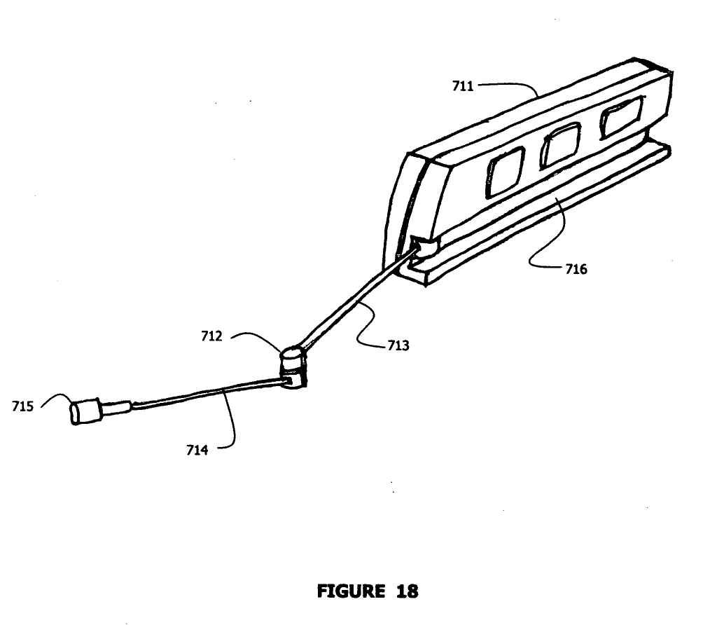

FIG. 16 illustrates a headset 770 with a telescoping boom according to some embodiments of the present invention. A telescoping microphone boom 772 is seen in its stowed position 778 alongside the main body 771 of the headset 770. An earpiece 777 is attached to the main body 771. The microphone boom 772 is adapted to deploy and to position the microphone 773 closer to the user's mouth. The first boom section 774 slides out along the outside of the main body 771 along a runner 776. A second boom section 775 deploys out from the first boom section 774 in a telescoping fashion. In some embodiments, the second boom section 775 is substantially straight while in a stowed position but takes on a curved shape when deployed. The second boom section may be of a shaped memory alloy or other superelastic material which is adapted to curve the section when deployed.

FIGS. 17 and 18 are sketches of a headset 710 with another type of deployable microphone boom according to some embodiments of the present invention. The microphone boom 712 is adapted to deploy from a stowed position in a slot 716 outside the main body 711 to a deployed position which positions the microphone 715 closer to the user's mouth. A first boom section 713 and a second boom section 714 are folded out to allow for the deployment of the boom 712.

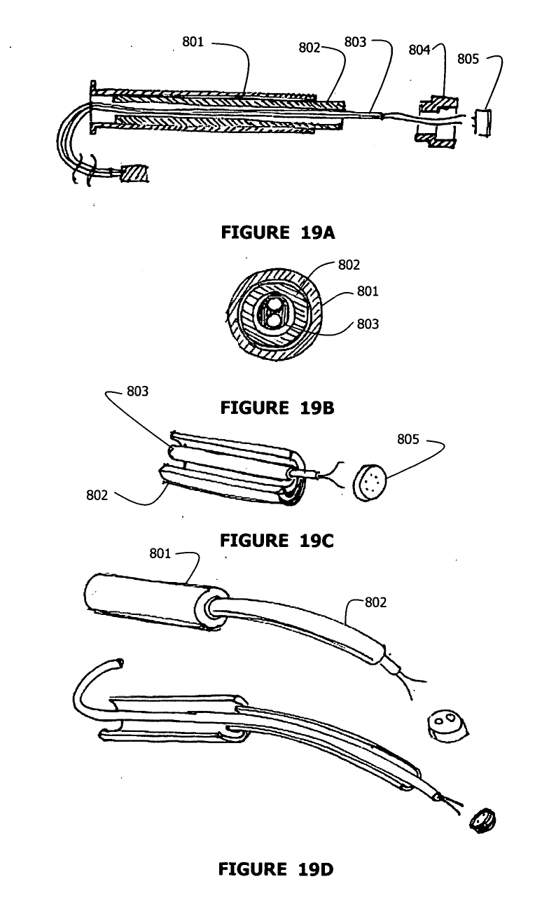

FIGS. 19A-D illustrate microphone wiring for a deployable microphone boom according to some embodiments of the present invention. A first boom section 801 and a second boom section 802 are seen in exploded views and various partial cross-sections. Wiring 803 is routed through the hollow boom sections to the microphone 805. Typically, two conductors will be routed to the microphone 805. In some embodiments, the boom itself may function as one of the conductors. A grommet 804 may be used to mount the microphone 805 to the end of the second boom section 802. As seen in FIG. 19D, the second boom section 802 may take a curved shape when deployed, although in a substantially straight shape while stowed. The wiring 803 may be a twisted pair of conductors, each individually insulated, with a secondary jacket around the pair. Because of the need for fine wire due to the small space that may be available within the boom, the conductor gauge may be on the order of AWG 40. In order to protect this wire from strain when the microphone and boom are stowed and deployed, which may pull on the wiring, the wiring may be infused with a strong material, such as kevlar, adapted to take the stress of axial pulling on the wiring and to off load the conductors. In some embodiments, the wiring may be coaxial.

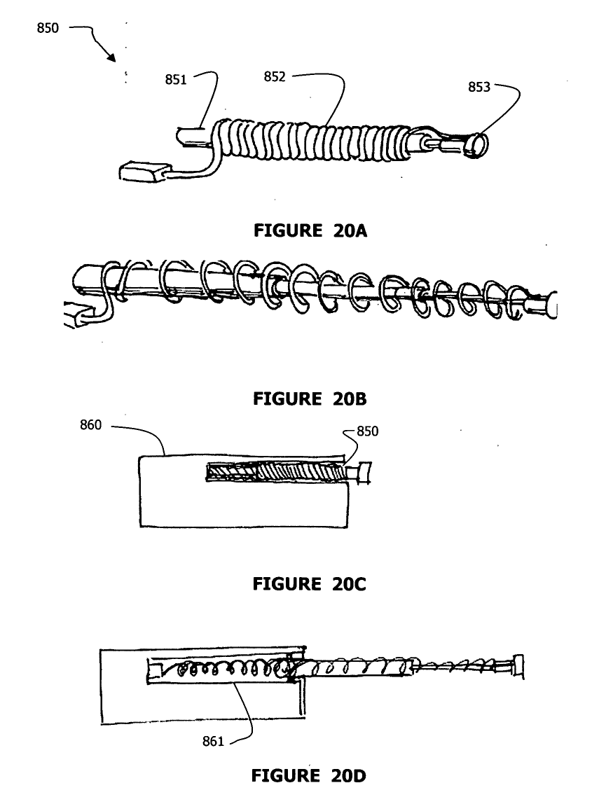

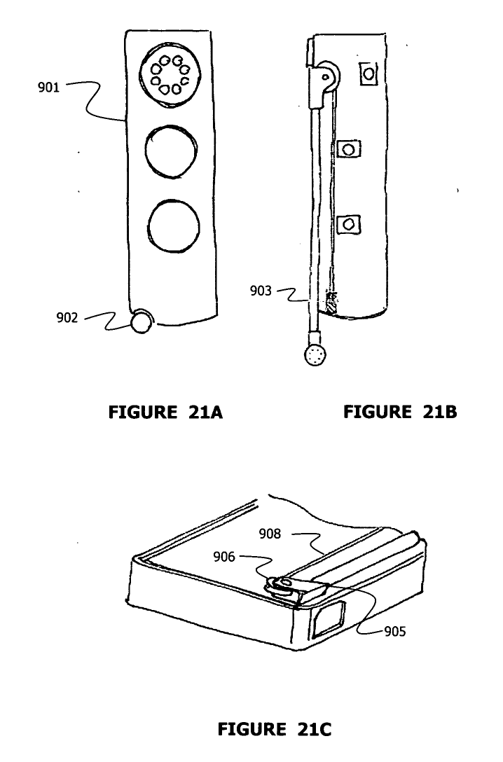

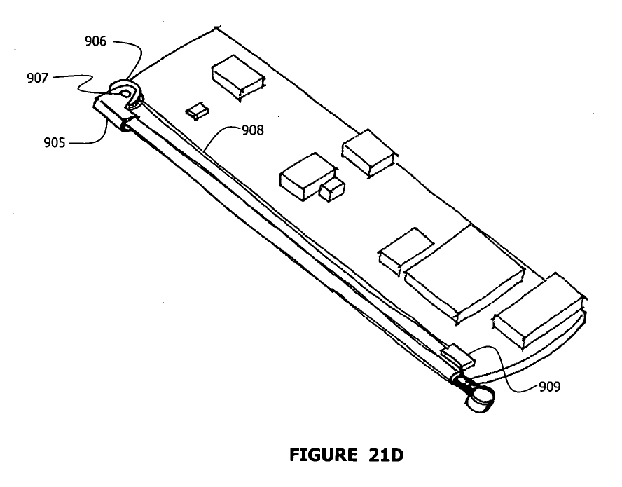

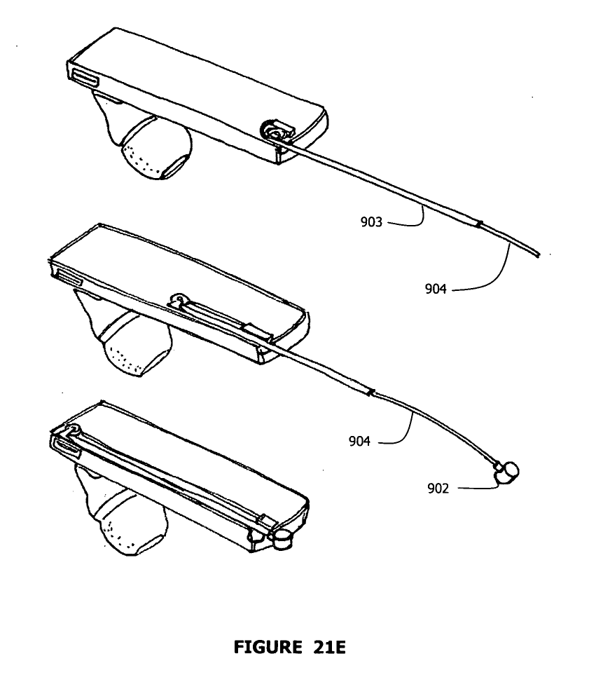

FIGS. 20A-D illustrate a microphone wiring system for a deployable microphone boom according to some embodiments of the present invention. A wired boom 850 includes an extendable microphone boom 851 wrapped with wiring 852 which connects to the microphone 853. As the microphone boom extends, the wrapped nature of the wiring 852 allows for the extension of the wiring in concert with the boom. The wiring 852 may have a sheath which deploys out with the boom in some embodiments. The preformed wrap of the wiring may also allow for the orderly retraction of the wiring with the stowage of the boom. As seen in illustrative partial cross-section in FIGS. 21C-D, the wired boom 850 resides within a space 861 in the main body 860.

FIGS. 21A-D illustrate a microphone wiring and deployment system for a deployable microphone boom according to some embodiments of the present invention. FIG. 21A illustrates a headset with a main body 901 and a deployable microphone 902, with the microphone 902 shown in the stowed position. FIGS. 21B-E show partial cutaway views of the headset illustrating a boom deployment and wiring system. The microphone boom is a two piece boom in this embodiment. A wire 908 adapted for electrical communication with the microphone 902 is anchored within the housing with a wiring anchor block 909. The microphone boom has a first boom portion 903 and a second boom portion 904. The second boom portion 904 is adapted to stow within the first boom portion 903 when the boom is stowed. In some embodiments, the boom portions are made of a superelastic material, such as nitinol. In some embodiments, the second boom portion 904 will take a curved shape when deployed, yet will become substantially straight when stowed into and constrained by the straight first boom portion 903. In some embodiments, the boom portions are prevented from overdeployment by the wiring system, which is of a length to allow for full deployment but not over deployment. In some embodiments, there may be a slight neck down in one boom section and a slight flare out in the interior boom section which prevents overdeployment.

The microphone wiring and deployment system is designed such that the portion of wire which is exposed outside of the boom when the boom is fully stowed is of sufficient length such that it is taken up into the boom when the boom is deployed. A slider 905 is attached to the inboard end of the first boom portion 903 and is adapted to slide along a runner to deploy the boom from within the main body 901 to a deployed position. In some embodiments, the runner may be the edge of a pc board, and the slider may have a slot or groove adapted to slide along the runner. A pulley 906 is attached to the slider 905 at a rotation axis 907. FIG. 21 E illustrates a sequence of deployment positions from stowed to deployed. As the microphone and microphone boom are deployed, as when the user pulls the end of the boom from the main body, the slider begins to slide along the runner. As the slider begins to slide along the runner, the exposed portion of the wire, which had been outside of the boom in the stowed position, is routed around the pulley and into the hollow boom. As the boom length is increasing as the second boom portion is extended out of the first boom portion, the exposed portion of the wire is taken up into the lengthening boom. The portion of the wire which is in the second boom portion 904 stays within the second boom portion both when the boom is fully stowed and also during deployment.

When the user decides to stow the microphone, such as by pushing the microphone boom back into the main body 901, the slider 905 is pushed inward as well. The retreat of the second boom section 904 into the first boom section 903 reduces the length of the boom, and also the amount of wire length in the boom. This wire retreats back around the pulley 906, and as the slider returns to the stowed, fully inboard position, the remaining wire that had been in the first boom section 903 returns to its position as the exposed portion of the wire in the stowed position. This microphone wiring and deployment system allows for an extendable boom while using a minimum of space within the main body 901 for the boom and wiring.

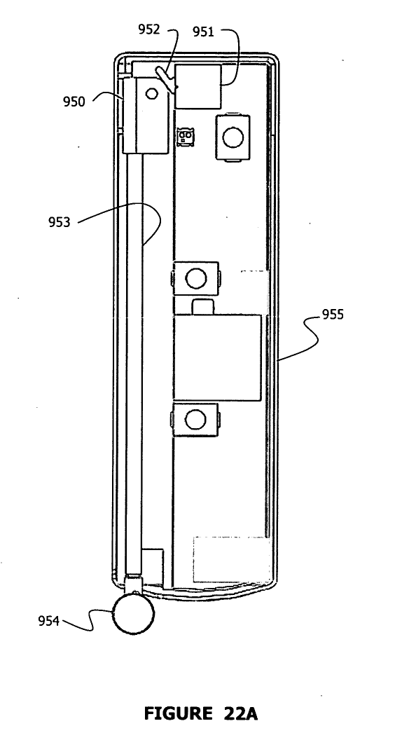

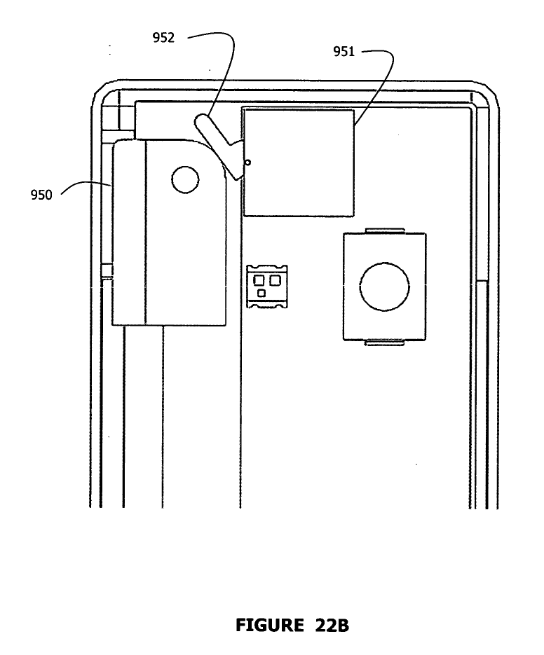

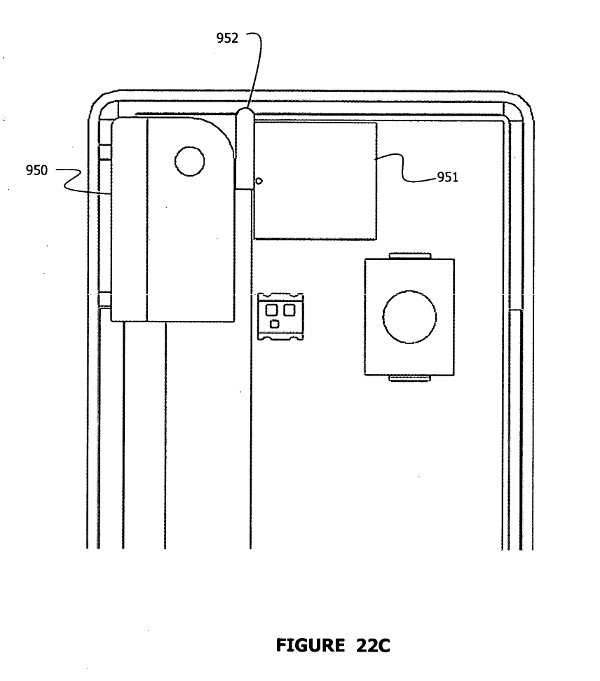

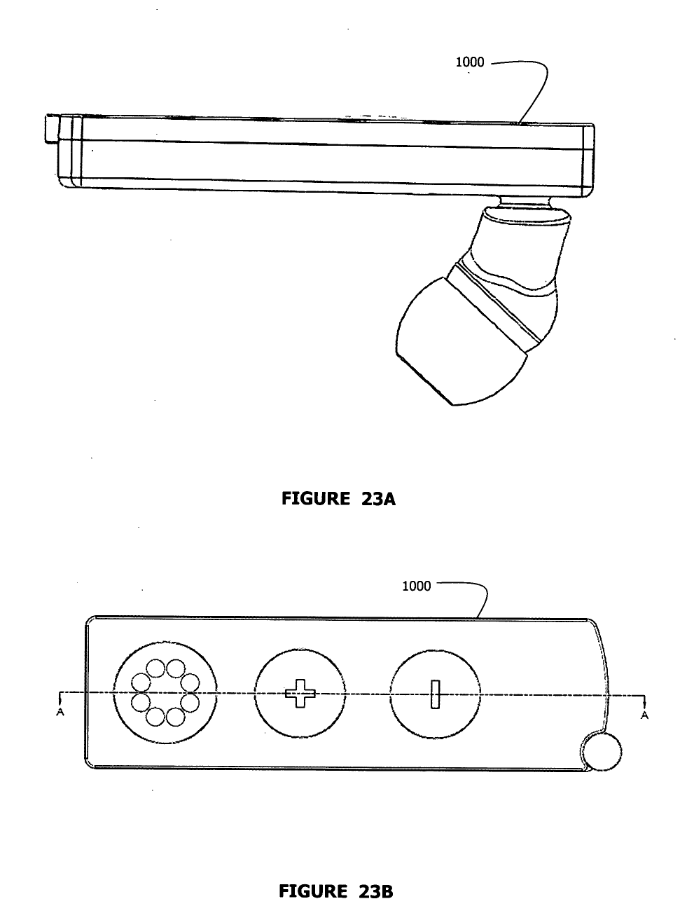

In some embodiments of the present invention, the electronics within the headset may alter the gain of the microphone depending upon whether the microphone is stowed or deployed. If the headset is used with the microphone stowed, the microphone may be significantly further from the user's mouth than when the microphone is deployed, thus is may be advantageous to compensate for this difference electronically. FIGS. 22A-C illustrate a partial cutaway view of a headset with a microphone boom deploy switch according to some embodiments of the present invention. As seen in FIGS. 22A and 22B, a headset 955 is shown with a microphone boom 953 in a partially deployed position. The microphone 954 is just partially deployed in these figures. The microphone 954 is attached to the microphone boom 953, which in turn is attached to a slider 950. A microswitch 951 is mounted within the headset. The microswitch 951 has a switch lever 952. As the microphone boom begins to deploy, the slider 950 moves away from the fully stowed position and allows the switch lever 952 to swing out, toggling the microswitch 951. FIG. 22C illustrates the slider 950 in the fully stowed position, wherein the switch lever 952 is pressed and provides an electrical signal via the microswitch 951 that the microphone is stowed. The microswitch may be used to indicate to the headset electronics whether the microphone is stowed or deployed. In some embodiments, the electronics are adapted to utilize a binary signal from the microswitch to vary between two preset gain levels. The gain levels may be embedded within the electronics or may be programmable into the electronics. In some embodiments, the boom deployment sensor system may utilize an optical sensor, a Hall effect sensor, or other device.

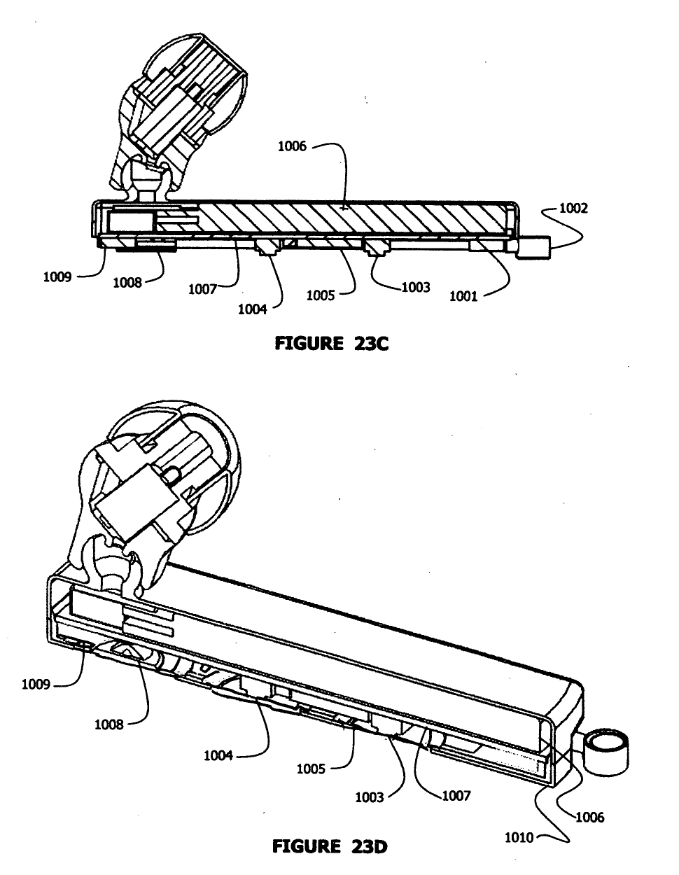

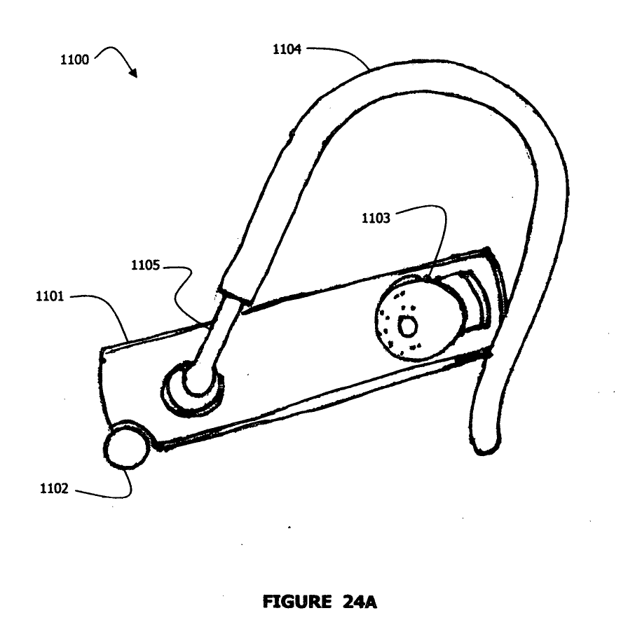

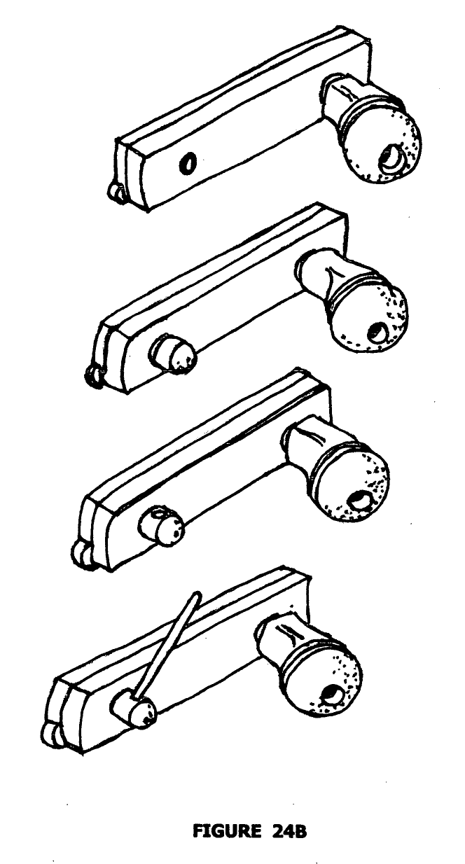

FIGS. 23A-D illustrate a headset according to some embodiments of the present invention including the internal configuration for a miniature headset configured for wireless use. FIG. 23A illustrates a side view of a miniature headset with a stowed microphone and an earpiece connected to the main body with a flexible joint according to some embodiments of the present invention. FIG. 23B illustrates a back view of a headset 100 showing two button switches and an LED panel. FIGS. 23C and D illustrate a cutaway view of the headset 1000 in orthogonal and perspective view, respectively, demonstrating an internal configuration. The housing 1010 contains electronics and other components adapted for wireless communication. A pc board 1007 is seen with an integrated circuit 1005 mounted thereon. In some embodiments, the integrated circuit 1005 is adapted for Bluetooth communication. A battery 1006 provides power for the headset. The limit switch 1009 is used to alter the gain for the microphone 1002 depending upon whether it is stowed or deployed. Two switches 1003, 1004 are used to allow for inputting direction from the outside of the headset using buttons. An three color LED 1008 is used to visually indicate functionalities to the user. An antenna 1001 is also mounted to the pc board 1007. One can see that the housing 1000 has been elegantly packed to provide for full functionality in a very small package.

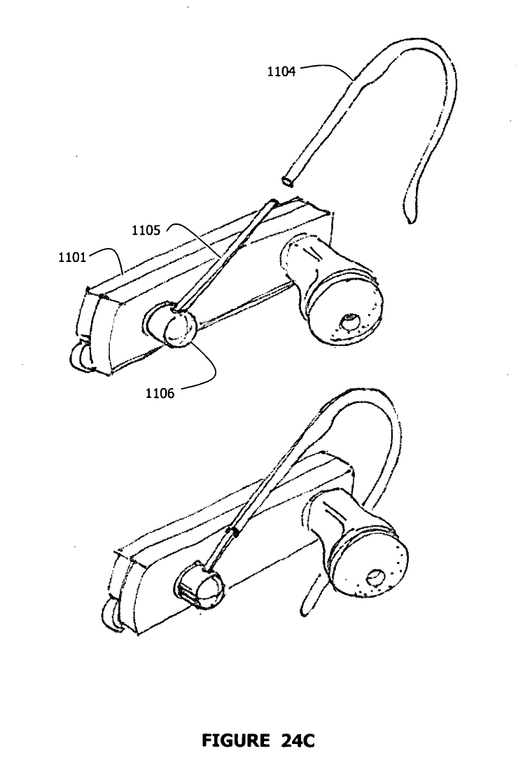

FIGS. 24A-C illustrate a headset 1100 with an earloop 1104 according to some embodiments of the present invention. The main body 1101 is attached to an earpiece 1103. In some embodiments, the earpiece 1103 is attached with a flexible joint. The microphone 1102 is seen at one end of the main body 1101. In some embodiments, the microphone 1102 will deploy in accordance with other aspects of embodiments of the present invention. A bulb 1106 is adapted to position a cheek pin 1105 along the inner surface of the main body 1101 of the headset 1100. An earloop 1104 is placed over the cheek pin 1105 and is adapted to support the headset over the user's ear.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

We claim:

1. A headset comprising:
a main body;
an earpiece for providing an audio output, said earphone attached to said main body; and
a microphone; said microphone attached to an extendable boom; and
an extendable boom, said extendable boom adapted to deploy from a first position substantially within said main body to a second postion outside said main body.

2. The headset of claim 1 wherein said extendable boom is in a first shape while in said first position, and is in a second shape while in said second position.

3. The headset of claim 2 wherein said first shape is substantially straight.

4. The headset of claim 2 wherein said second shape is curved.

5. The headset of claim 3 wherein said second shape is curved.

6. The headset of claim 5 wherein said extendable boom comprises a shaped memory alloy.

7. The headset of claim 6 wherein said extendable boom comprises nitinol.

8. The headset of claim 4 wherein the deployed length of said extendable boom is substantially as long as the length of said main body.

9. The headset of claim 4 wherein said extendable boom has a deployed length equal to or greater than 80% of the length of said main body.

10. The headset of claim 5 wherein said earpiece is attached to said main body with a flexible joint.

11. The headset of claim 10 wherein said earpiece is attached to said main body with a ball and socket joint.

12. The headset of claim 1 further comprising:
a second earpiece; and
a cable, said cable coupled to said second earpiece on a first end, said cable coupled to said main body on a second end.

13. The headset of claim 1 further comprising:
a boom deployment switch, said boom deployment switch adapted to indicate when said extendable boom is in a stowed position.

14. A headset comprising:
a main body;
an earpiece for providing an audio output, said earpiece attached to said main body; and
a microphone attached to an extendable boom, and an extendable boom, said extendable boom extendable from within said main body, wherein said extendable boom comprises:
a first boom section; and
a second boom section, said second boom section adapted to telescope within said first boom section.

15. The headset of claim 14 wherein said first boom section and said section boom section are adapted to extend from a stowed position predominantly within said main body to a deployed position predominantly out of said main body.

16. The headset of claim 15 wherein a first end of said first boom section is attached to said main body in said deployed position, and wherein said second boom section extends from the second end of said first boom section in said deployed position.

17. The headset of claim 16 wherein said second boom section is substantially unable to rotate relative to said first boom section at the junction of said second boom section with said first boom section.

18. The headset of claim 17 wherein said first boom section is substantially unable to rotate relative to said main body at the attachment between said first boom section and said housing.

19. The headset of claim 16 wherein said first boom section and said section boom section are substantially straight when in said stowed position.

20. The headset of claim 19 wherein said second boom section is curved when in said deployed position.

21. The headset of claim 20 wherein said second boom section comprises a shaped memory alloy.

22. The headset of claim 21 wherein said second boom section comprises nitinol.

23. The headset of claim 14 further comprising a wire, said wire connected to said microphone, said wire routed to said microphone along the inside of said extendable boom.

24. The headset of claim 16 wherein the deployed length of said extendable boom is substantially as long as said main body.

25. The headset of claim 16 wherein said deployed length of said extendable boom is longer than said main body.

26. The headset of claim 20 wherein said deployed length of said extendable boom is longer than said main body.

27. The headset of claim 19 wherein said deployed length of said extendable boom is greater than 150% of the length of said main body.

28. A headset comprising:
a main body;
an earpiece, said earpiece movably attached to said main body.

29. The headset of claim 28 wherein said earpiece is movably attached to said main body with a flexible joint, said flexible joint comprising:
a socket engaging end surface; and
an internal socket receiving cavity.

30. The headset of claim 28 wherein said main body comprises a socket engaging end surface.

31. The headset of claim 30 wherein said earpiece comprises an internal socket receiving cavity.

32. The headset of claim 30 wherein said earpiece further comprises a speaker.

33. The headset of claim 32 wherein one or more wires travels from said main body through said flexible joint to said speaker.

34. The headset of claim 30 wherein said main body further comprises a speaker.

35. The headset of claim 34 wherein said flexible joint is adapted to channel sound from said speaker to said earpiece.

36. The headset of claim 29 further comprising:
a second earpiece; and
a cable, said cable coupled to said second earpiece on a first end, said cable couple to said main body on a second end.

37. A headset adapted for wireless communication, said headset comprising:
a main body, said main body comprising electronics adapted for wireless communication; and
an earpiece, said earpiece attached to said main body with a flexible joint.

38. The headset of claim 37 wherein said flexible joint comprises a socket engaging end surface and an internal socket receiving cavity.

39. The headset of claim 38 wherein said flexible joint comprises a first hole through the flexible joint.

40. The headset of claim 39 wherein said earpiece further comprises a speaker.

41. The headset of claim 40 wherein said headset further comprises a first set of wires, said first set of wires adapted to provide electronic communication from said headset to said speaker, said wires routed through said first hole.

42. The headset of claim 39 wherein said headset comprises a speaker, said speaker positioned relative to said flexible joint such that said first hole channels sound from said speaker to said earpiece.

43. The headset of claim 37 further comprising:
a microphone; and
a extendable microphone boom, said microphone boom adapted to allow movement of said microphone from a stowed position in or adjacent to said main body to a deployed position further from said main body.

44. The headset of claim 38 further comprising:
a microphone; and
a extendable microphone boom, said microphone boom adapted to allow movement of said microphone from a stowed position in or adjacent to said main body to a deployed position further from said main body

45. A headset adapted for wireless communication, said headset comprising:
a main body, said main body comprising electronics adapted for wireless communication;
an earpiece, said earpiece attached to said main body;
a microphone, said microphone electrically couple to said electronics; said microphone attached to an extendable microphone boom; and
an extendable microphone boom, said microphone boom adapted to allow movement of said microphone from a stowed position in or adjacent to said main body to a deployed position further from said main body.

46. The headset of claim 45 further comprising:
a boom deployment switch, said boom deployment switch adapted to indicate when said extendable boom is in a stowed position.

47. The headset of claim 46 wherein said electronics are adapted to provide a first gain for said microphone when said extendable microphone boom is in a stowed position and to provide a second gain for said microphone when said extendable microphone boom is in a deployed position.

48. The headset of claim 47 wherein the microphone gain is altered based upon the signal status of said boom deployment switch.

49. The headset of claim 46 wherein the microphone gain is altered based upon the signal status of said boom deployment switch.

50. The headset of claim 45 wherein said extendable microphone boom comprises a first portion and a second portion, said first portion adapted to telescope into said second portion when said boom is in said stowed position.

51. The headset of claim 50 wherein the extended length of said microphone boom is longer than the length of said main body.

52. The headset of claim 45 wherein said microphone boom is substantially straight when in said stowed position and is curved when in said deployed position.

53. The headset of claim 50 wherein said first portion is substantially straight when in said stowed position and is curved when in said deployed position.

54. The headset of claim 52 wherein said boom comprises nitinol.

55. The headset of claim 53 wherein said boom comprises nitinol.

56. The headset of claim 45 wherein said ear piece is attached to said main body with a flexible joint.

57. The headset of claim 52 wherein said earpiece is attached to said main body with a flexible joint.

58. The headset of claim 57 wherein said flexible joint comprises a socket engaging end surface and an internal socket receiving cavity.
